(19) United States
(12) Patent Application Publication
(10) Pub. No.: US 2023/0324553 A1
(43) Pub. Date: Oct. 12, 2023

(54) METHOD, APPARATUS, AND SYSTEM FOR EXTRACTING POINT-OF-INTEREST FEATURES USING LIDAR DATA CAPTURED BY MOBILE DEVICES

(71) Applicant: HERE Global B.V., Eindhoven (NL)

(72) Inventors: Remco TIMMER, Amsterdam (NL); Jérôme BEAUREPAIRE, Berlin (DE)

(21) Appl. No.: 17/716,760

(22) Filed: Apr. 8, 2022

(51) Int. Cl. G01S 17/89; G06T 7/73; G06F 16/29

(52) U.S. Cl. CPC G01S 17/89; G06T 7/73; G06F 16/29; G06T 2207/20104; G06T 2207/30181

(57) ABSTRACT

An approach is provided for extracting point-of-interest features based on depth sensor data captured by mobile devices. The approach involves, for instance, receiving a Light Detection and Ranging (LiDAR) scan of a location captured using a LiDAR sensor of a portable device. The approach also involves determining a context of the location, a point of interest (POI) associated with the location, or a combination thereof. The approach further involves selecting a feature recognition parameter based on the context. The feature recognition parameter performs a feature detection analysis of a scenery depicted in the scan. The approach further involves initiating the feature detection analysis of the scan based on the feature recognition parameter to identify a feature, an attribute of the feature, or a combination thereof in the scenery.

### BACKGROUND

Point-of-interest (POI) updates are usually performed by their owners and/or operators, or shared by users via social media using portable devices (e.g., mobile phones, wearable devices, etc.). However, the owners/operators may not provide sufficient details (e.g., a desk dimensions in a hotel room) while the use of social media may potentially compromise privacy (e.g., by exposing a person's—device user or other POI visitor—appearance and/or precise location coordinates). Accordingly, service providers face significant technical challenges to develop alternative POI feature extracting and updating technologies, e.g., when existing approaches are not sufficient or otherwise not suitable for required privacy.

### SOME EXAMPLE EMBODIMENTS

Therefore, there is a need for an approach for extracting POI features using venue scans using, for example, depth-sensing technologies such as camera and/or Light Detection and Ranging (LiDAR) sensors (which are becoming increasingly common on portable devices e.g., mobile phones, augmented reality glasses, etc.).

According to one embodiment, a method comprises receiving a Light Detection and Ranging (LiDAR) scan of a location captured using a LiDAR sensor of a portable device. The method also comprises determining a context of the location, a point of interest (POI) associated with the location, or a combination thereof. The method further comprises selecting a feature recognition parameter based on the context. The feature recognition parameter performs a feature detection analysis of a scenery depicted in the LiDAR scan. The method further comprises initiating the feature detection analysis of the LiDAR scan based on the feature recognition parameter to identify a feature, an attribute of the feature, or a combination thereof in the scenery.

According to another embodiment, an apparatus comprises at least one processor, and at least one memory including computer program code for one or more computer programs, the at least one memory and the computer program code configured to, with the at least one processor, cause, at least in part, the apparatus to receive a Light Detection and Ranging (LiDAR) scan of a location captured using a LiDAR sensor of a portable device. The apparatus is also caused to determine a context of the location, a point of interest (POI) associated with the location, or a combination thereof. The apparatus is further caused to select a feature recognition parameter based on the context. The feature recognition parameter performs a feature detection analysis of a scenery depicted in the LiDAR scan. The apparatus is further caused to initiate the feature detection analysis of the LiDAR scan based on the feature recognition parameter to identify a feature, an attribute of the feature, or a combination thereof in the scenery.

According to another embodiment, a computer-readable storage medium carries one or more sequences of one or more instructions which, when executed by one or more processors, cause, at least in part, an apparatus to receive a Light Detection and Ranging (LiDAR) scan of a location captured using a LiDAR sensor of a portable device. The apparatus is also caused to determine a context of the location, a point of interest (POI) associated with the location, or a combination thereof. The apparatus is further caused to select a feature recognition parameter based on the context. The feature recognition parameter performs a feature detection analysis of a scenery depicted in the LiDAR scan. The apparatus is further caused to initiate the feature detection analysis of the LiDAR scan based on the feature recognition parameter to identify a feature, an attribute of the feature, or a combination thereof in the scenery.

According to another embodiment, a computer program product may be provided. For example, a computer program product comprising instructions which, when the program is executed by a computer, cause the computer to receive a Light Detection and Ranging (LiDAR) scan of a location captured using a LiDAR sensor of a portable device. The computer is also caused to determine a context of the location, a point of interest (POI) associated with the location, or a combination thereof. The computer is further caused to select a feature recognition parameter based on the context. The feature recognition parameter performs a feature detection analysis of a scenery depicted in the LiDAR scan. The computer is further caused to initiate the feature detection analysis of the LiDAR scan based on the feature recognition parameter to identify a feature, an attribute of the feature, or a combination thereof in the scenery.

According to another embodiment, an apparatus comprises means for receiving a Light Detection and Ranging (LiDAR) scan of a location captured using a LiDAR sensor of a portable device. The apparatus also comprises means for determining a context of the location, a point of interest (POI) associated with the location, or a combination thereof. The apparatus further comprises means for selecting a feature recognition parameter based on the context. The feature recognition parameter performs a feature detection analysis of a scenery depicted in the LiDAR scan. The apparatus further comprises means for initiating the feature detection analysis of the LiDAR scan based on the feature recognition parameter to identify a feature, an attribute of the feature, or a combination thereof in the scenery.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the portable device side or in any shared way between service provider and portable device with actions being performed on both sides.

For various example embodiments, the following is applicable: An apparatus comprising means for performing the method of any of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1A is a diagram of a system for extracting POI features using depth sensor data (e.g., Light Detection and Ranging (LiDAR) data) captured by mobile devices, according to example embodiment(s);

FIG. 1B is a diagram illustrating an example LiDAR scan, according to example embodiment(s);

FIG. 1C are diagrams illustrating example POIs, according to example embodiment(s);

FIG. 2 is a diagram of the components of a location application and/or location platform capable of extracting POI features using LiDAR data captured by mobile devices, according to example embodiment(s);

FIG. 3 is a flowchart of a process for extracting POI features based on depth sensor data captured by mobile devices, according to example embodiment(s);

FIGS. 4A-4D are diagrams illustrating example user interfaces for capturing LiDAR scan(s) and extracting POI features, according to example embodiment(s);

FIGS. 5A-5B are diagrams illustrating example user interfaces for using extracted POI features, according to example embodiment(s);

FIG. 6 is a diagram of geographic database, according to example embodiment(s);

FIG. 7 is a diagram of hardware that can be used to implement various example embodiments;

FIG. 8 is a diagram of a chip set that can be used to implement various example embodiments; and

FIG. 9 is a diagram of a mobile terminal that can be used to implement various example embodiments.

### DESCRIPTION OF SOME EMBODIMENTS

Examples of a method, apparatus, and computer program for extracting POI features using depth sensor data are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

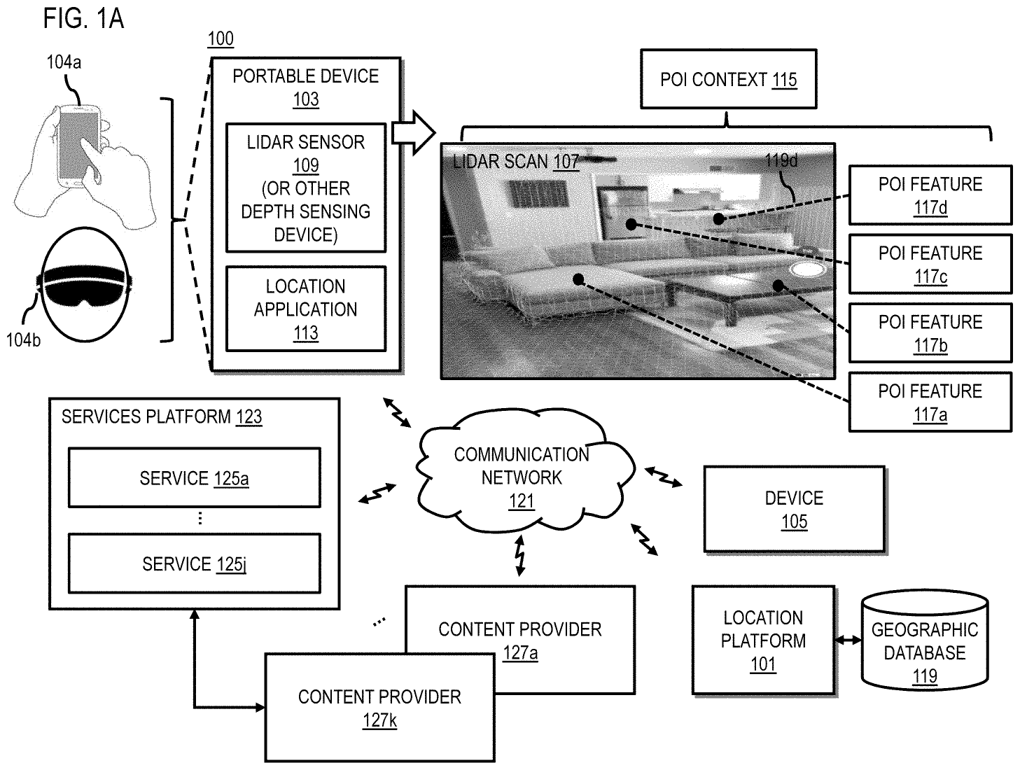

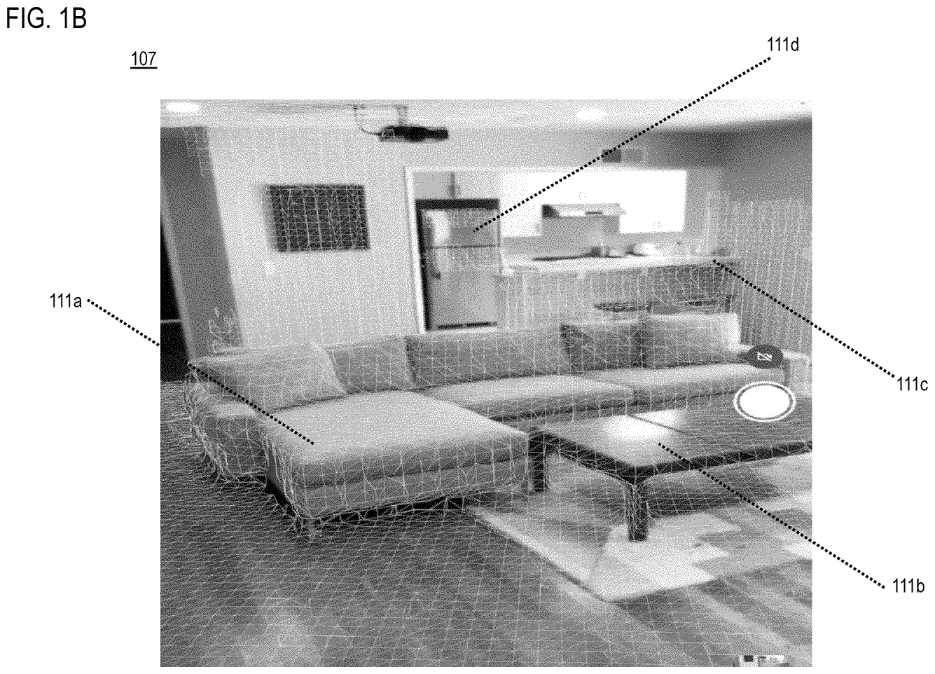

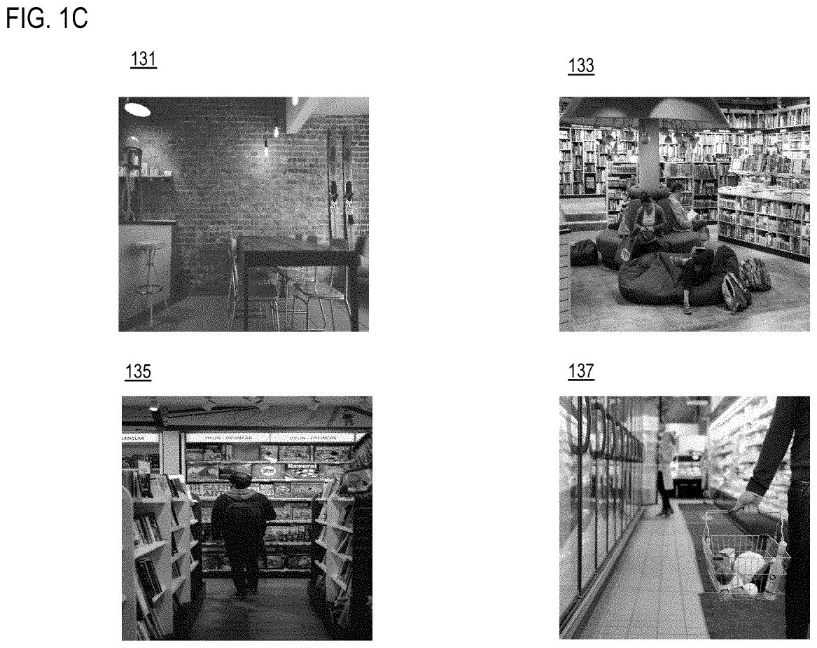

FIG. 1 is a diagram of a system for extracting POI features using depth sensor data (e.g., Light Detection and Ranging (LiDAR) data) captured by mobile devices, according to example embodiment(s). As discussed above, one area of development for mapping and navigation services providers (e.g., provider of a location platform 101) is in the area of extracting and updating POI features using a portable device 103 (e.g., a mobile phone 104a, augmented-reality device 104b, wearable device (not shown), head-mounted device (not shown), tablet (not shown), portable computer (not shown), etc.) and other devices 105 (e.g., other portable devices and/or any other device capable of sharing locations). As used herein, a “portable device” refers to any device that a user can hold, wear, carry, or otherwise be attached to. In particular, technical challenges involve overcoming the limitations of existing POI updating approaches, such as updates by POI owners/operators, user social media posts, etc.

For instance, the POI owners/operators may not disclose every feature of the POIs, such as shortcomings (e.g., narrow seats), or with insufficient details (e.g., furniture dimensions like conference room table sizes), etc. Other methods of POI updating (e.g., sharing on social media an image captured by a camera on the device) can potentially raise privacy concerns by depicting privacy sensitive information (e.g., faces, interior spaces, license plates, and/or any other personally identifiable features).

To address these technical challenges, a system 100 of FIG. 1A introduces a capability of leveraging/applying knowledge of a POI (e.g., POI context 115 such as a POI type) to get more precise idea of what the system 100 is supposed to recognize, what to highlight in the scene, what is important and relevant for such a POI. The system 100 can use context/historical information about a location/POI to determine what types of features/attributes are likely to be at a location and then optimize the feature recognition process to identify the likely objects, instead of identifying every object from scratch with even likelihood of all object types. In other words, the system 100 can use the POI context as a container entity to save recognition time.

For instance, the system 100 can retrieve LiDAR scan(s) (e.g., a LiDAR scan 107) from a device (e.g., a portable device 103 such as but not limited to a mobile phone including a LiDAR sensor 109). For instance, FIG. 1B is a diagram illustrating an example LiDAR scan (e.g., the LiDAR scan 107), according to example embodiment(s). Such scan 107 includes multiple point clouds 111a-111d (collectively as point clouds 111) each of which contains a set of points that describe an object or surface, and each of the points contains an amount of data (e.g., location, color, material, etc.) that can be integrated with other data sources or used to create 3D models. In this case, the multiple point clouds 111a-111d of a sofa, a desk, a bar table, and a refrigerator correspond to POI features 117a-117d of a room (e.g., a hotel room, a private rental room (e.g., Airbnb), etc.).

On top of the POI context (e.g., the POI type extracted form a map database based on the location data), the system 100 can leverage historical feature (e.g., object) patterns of LiDAR scans made by this user in the past. Knowing that a user is at a given POI type, the system 100 can know what it is supposed to see at the POI and the number of the features. Besides objects (e.g., appliances, cups, dishes, books, food, etc.), The features can include furniture (e.g., tables, chair, bars, shelves, etc.), decorations (e.g., patterns, colors, lighting, etc. on walls, celling, windows, etc.), etc. FIG. 1C are diagrams illustrating example POIs, according to example embodiment(s). For instance, a restaurant is supposed to have tables (of possibly different sizes) and chairs, generally with some predefined space between the tables to keep the customers comfortable. A restaurant in an image 131 has a wooden dining table with plastic chairs, a counter with a bar stool, a brick wall, a sauce shelf on the wall, two skis against the wall, and two lights.

A library in an image 133 has people on a circular sofa, a bean bag chair, the backpacks on the floor, and many bookshelves. A record store in an image 135 has one person, and record bookshelves. A supermarket in an image 137 has one person carrying a shopping basket, another person opening a freezer, and many product shelves. As shown in FIG. 1C, different POIs have different features, such that the system 100 can quicker identify features in a known POI type by setting the features of the known POI type with higher probabilities than other features usually absent from the POI type, when applying a feature recognition algorithm on a LiDAR scan.

For instance, knowing that a user is in a POI of type X (e.g., a hotel), and a hotel room usually has features of types M, N, O (e.g., a sofa, a bed, a table, etc.) as identified by the portable device 103 and/or other similar devices. The system 100 can select different object type classifier based on the determined context (e.g., a POI type). When applying a feature recognition algorithm on the LiDAR scan 107, the system 100 can set the feature types M, N, O with higher probabilities (e.g., 90%) than other feature types (e.g., 5% portability of supermarket furniture such as product shelves in Image 137) usually absent from a hotel room, in order to increase the recognition efficiency. The system 100 can compare a point cloud taken by the device with reference point clouds, e.g., in cloud, edge device, or another device (e.g., pre-captured via crowdsourcing).

By way of example, the system 100 can compare a point cloud of an object Y (e.g., the sofa) in the LiDAR scan 107 to the point clouds of the object types M, N, O (e.g., sofa, a reception desk, a luggage trolley, etc.) in a hotel room, to generate POI features 117a-117d (also collectively referred to as POI features 117) such as object types, numbers, spatial dimensions, arrangements, etc.

In another embodiment, the system 100 can compare the newly identified POI features with the previously identified POI features at the same POI to identify any changes. For instance, when the system 100 detects that there was a POI feature change, e.g., more chairs are now detected, the system 10 can further determine either the POI type changed (e.g., from a restaurant to a bar or a dance floor) or just the layout inside changed (e.g., from a Spanish restaurant to a French restaurant). The more information (e.g., POI type, opening hours, occupancy information, indoor pictures, etc.), the better to determine either case as described later.

In another embodiment, the system 100 can consider timing data (e.g., time of the day/week/season/year) of the LiDAR scans, and determine whether to update the POI type further based on the timing data. For instance, a restaurant is turned into a dance floor only at night, so the system 100 can store two different POI types for the same place in the database and update the relevant POI description accordingly.

It is noted that although the various embodiments described herein are discussed with respect to using the LiDAR sensor 109 of the portable device 103 to generate LiDAR scans, it is contemplated that any other type of depth sensing sensor (e.g., stereoscopic camera arrangements up to a limited distance, or any other time-of-flight sensor capable of generating a point cloud representation of an environment) can be used equivalently in the embodiments described herein. By way of example, a LiDAR sensor 109 scans an environment by transmitting laser pulses to various points in the environment and records the time delay of the corresponding reflected laser pulse as received at the LiDAR sensor 109. The distance from the LiDAR sensor 109 to a particular point in the environment can be calculated based on the time delay. When the distance is combined with an elevation of the laser pulse as emitted from the LiDAR sensor 109, a three-dimensional (3D) coordinate point can be computed to represent the point on a surface in the environment to which the laser pulse was directed. By scanning multiple points in the environment, the LiDAR sensor 109 can generate a three-dimensional (3D) point cloud representation of the environment (e.g., LiDAR scan 107). In one embodiment, the LiDAR sensor 109 sensor can be a hyperspectral sensor that scans the environment with laser pulses at different wavelengths to determine additional surface characteristics (e.g., surface material, etc.). For example differences in the time delay at different wavelengths can be indicative of differences in surface characteristics, and thus can be used to identify a surface characteristic. These additional characteristics can also be included in the POI features 117.

In one embodiment, the POI features 117 can be computed from the LiDAR scan 107 (e.g., by extracting features from the 3D point cloud, subsampling the 3D point cloud, cropping the 3D point cloud, etc.). Such POI features 117 can provide information about where the device is located, information about features found at the location, and/or information about other characteristics/attributes associated with the location, among other possibilities. In one embodiment, the portable device 103 (e.g., via a location application 113) can share the POI features 117 with another device 105 (i.e., effect location sharing) or otherwise store the POI features 117 for later reference or use. In either case, the portable device 103 at issue (or another device 105 that obtained the POI features 117) could use the POI features 117 to construct a 3D model for a POI for augmented reality and/or virtual reality applications. The POI features 117 can be used to update POI descriptions (e.g., POI type, furniture dimensions, estimated busyness, etc.), so as to facilitate refined applications such as searching for POIs (e.g., searching to rent or buy a house with a 9 ft×9 ft or bigger hot tub), making reservations of POIs (e.g., reserving a restaurant with at least 5-ft between tables).

In one embodiment, the portable device 103 can be a dead mounted device or any other wearable device that is equipped with a LiDAR sensor 109 or equivalent depth sensing sensor. In this use case, such head-mounted or wearable portable devices can make the capturing of a LiDAR scan 107 more intuitive and convenient, without having to lift a device to point in a direction to capture salient features of the environment.

In one embodiment, LiDAR scans 107 and/or corresponding POI features 117 can be stored on the cloud (e.g., in a geographic database 119 or equivalent data store of the location platform 101) over a communication network 121. In addition or alternatively, a services platform 123, one or more services 125a-125j (also collectively referred to as services 125), and/or one or more content providers 127a-127k (also collectively referred to as content providers 127) can provide cloud storage for the LiDAR scans 107 and/or POI features 117, and/or provide services or applications based on the LiDAR scans 107 and/or POI features 117, across a range of use cases discussed further below.

In one embodiment, the system 100 can leverage edge capabilities for live matching of POI features 117 locally at an edge device against with reference scans (e.g., stored at the edge device or retrieved from a cloud device). For instance, when users take LiDAR scans from indoor environments, the system 100 can compare the newly captured LiDAR scans with the POI information stored in a database (e.g., locally in the device 105 or in the geographic database 119) to check whether to update the POI features or the POI type.

When the difference is below a threshold, the system 100 can update the new POI feature(s) in the database and/or descriptions of the POI, such as a pool table of dimensions X, Y, a kicker table, etc. When the difference is equal to or above a threshold, the system 100 can compute a probability or confidence index to determine whether the POI type has changed, and then update the POI type accordingly, such as from a restaurant to a dance floor after midnight.

In another embodiment, the system 100 can estimate the crowdedness/busyness of a POI (e.g., counting objects/people with respect to available space, numbers of people per square meters, etc.) based on LiDAR scans and determine the type of activities (e.g., eating, dancing, reading, shopping, etc.) performed inside the POI, and update the database and/or POI descriptions accordingly. Different activities require different physical spacing among objects with respect to crowdedness.

Such live POI feature/type updates can significantly enrich the freshness of the database and/or POI descriptions via crowd-sourcing, thereby enabling various location based services. For instance, location based services such as hotel reservations can display automatic labeled elements/objects in a “Lidar scanned scene” to end users. The automatic labeled/tagged features within a scene can leverage existing labelling technologies to highlight features relevant for a particular user or service, such as stairs locations and a number of steps (e.g., important for impaired people), large windows facing views, a dining table of 2×2 for 6 people, a plane surface available in a room, a number of chairs, a ceiling height, etc.

With such information, the system 100 can generate summaries/inventories of features for users to know what is available in a room (e.g., in an office, hotel, home, school, etc.), and the users can search for accommodations/rooms that fit some “refined needs,” such as a hotel room with “large south facing windows” or with “ceilings over 3 m.” Similarly, users could filter some accommodations which would have some undesirable features, such as “not showing vacations homes with bunk beds or tables too small to for 6 people.”

In another embodiment, the system 100 can automatically embed routable links in the detected POI features (e.g., heated surface on the ground) for users to click for details.

In another embodiment, the system 100 can combine multiple sensors (e.g., LiDAR, accelerometer, magnetometer, gyroscope, barometer, pressure sensor, pedometer, microphone, etc.) to scan one or more rooms within a structure (e.g., a house, office building, mall, etc.) for detecting sound, music, air flow, smell, etc., and generated POI updates manually or automatically verify/transmit to the database and/or POI descriptions, such as How large are the beds in that hotel, how many beds? How high is the bunk bed? How large is the TV? How many tables are available?

For instance, the system 100 can initiate capturing additional sensor data representing an attribute of an environment of the location. For example, the additional sensor data may include or be based hyperspectral data collected by the LiDAR sensor 109. Hyperspectral data, for instance, includes time delay of reflected laser pulses determined across different wavelengths of light. The differences in the time delays among the different wavelengths for a given point or surface can be indicative of an attribute (e.g., type of material) of the surface in the environment. The system 100 can process the hyperspectral data to determine information about a material of an object and/or surface located in the environment of the location. The system 100 then can associate the additional sensor data, information determined from the additional sensor data, or a combination thereof with the POI features 117.

In one embodiment, the system 100 can use the delta between scans to determine the likelihood for a POI type to be obsolete. In another embodiment, the system 100 can adjust level granularity (e.g., for privacy purpose) via making some abstraction of the point cloud.

In terms of static object recognition, the system 100 can ask the user(s) to capture additional scans, for example, to decide whether the POI type changed scanning from a different perspective (e.g., left, right, back, etc.), with incentives (e.g., discounts, rewards, etc.). For instance, the system 100 can compare two 3D point clouds, the newly captured one with a previously captured one, to determine a POI type change, such as from a restaurant to a dance pop. The system 100 can use machine learning to distinguish mobile objects (e.g., table) from fixture (e.g., a bar counter). In another embodiment, the system 100 can tolerate to a POI feature change threshold (e.g., 30%), so as to distinguish moving around tables in the same restaurant into a dance floor after midnight or event-based (e.g., for a holiday party), instead of converting into a dance bar permanently (e.g., using machine learning).

The system 100 can put the data of a newly captured “available table surfaces” and a previously captured “available table surfaces” into a metric for comparison, so as to know how many tables are open. To determine the cuisine of the restaurant, the system 100 can analyze camera images of the objects on the table, such as dishes. For instance, the system 100 can augment camera images with LiDAR observations. In some cases, the system 100 can classify some objects more easily based on their images rather than their point-cloud scans, and determine to ignore certain objects of the LiDAR scan based on the objects being identified as irrelevant. In this scenario, the system 100 can focus on food in the dishes to determine the cuisine and simply ignore cups, flower vases, etc., even though they are picked up via LiDAR.

In other embodiments, the system 100 can apply the described embodiments to an outdoor environment with defined boundary, such as a park, and identify POI features, such as a swing set in playground, picnic tables, etc. By analogy, the system 100 can invite users to capture content, attributes or features related to an outdoor POI (e.g., kiosks in and around the Eiffel Tower) by utilizing knowledge related to the POI attributes. The system 100 can utilizes POI context (e.g., POI types) to get more precise idea of what to recognize, what to highlight in the scene, and what is important and relevant for such a POI. In terms of change detection, when the system 100 detects that there was a change in the POI type or feature(s) (e.g., more chairs are now detected), it can be either a POI type change or just layout changed.

The system 100 can extract POI features (e.g., objects, furniture, décor, etc.) expected to be found in POIs of the same POI type (e.g., a park) by leveraging as much information (e.g., details on the POI type, opening hours, occupancy information, indoor pictures, etc.) as possible in the POI, where the user is capturing the LiDAR scan. The currently visited POI type can be determined based on a user device proximity to know POIs in a map database. The system 100 may further estimate the busyness of a place with some LiDAR scans as well as the type of activities performed inside.

In other embodiments, the system 100 can apply the described embodiments to beyond a POI, such as a set of general location coordinates (e.g., according to the World Geodetic System (WGS84) coordinate system which is more precise than a POI), or an area with coarser granularity than a POI (e.g., an exhibition hall with many booths, a mall with various stores, etc.). The more precise the location is defined, the higher the features/attributes detection probability.

The various embodiments described herein provide for several technical advantages including but not limited to:
Contextual LiDAR scanning uses context/historical information of a location/POI to determine what types of features/attributes likely located there to optimize the feature recognition process and identify the likely features/attributes, instead of identifying every feature/attribute from scratch with equal probability of all feature/attribute types;
Privacy sensitive/compliant POI/feature updates as no personal information is captured (e.g., capturing 3D points of a point cloud representation or features extracted therefrom), in comparison, for instance, with a scene picture sharing (e.g., where visual characteristics are captured in more detail and can expose personally identifiable information);
More efficient in low-light conditions, compared to use of images (e.g., visual localization);
Acquisition speed/requirements (e.g., scan quality less susceptible to various movement(s) compared to use of images);
Depth sensing could help recognize a location from multiple angles because of 3D point capture, and is therefore, more robust that the two-dimensional capture of traditional images; and
Compared to LiDAR on cars, LiDAR on portable devices (e.g., mobile or wearable devices) can be placed in numerous locations and orientations in the environment (e.g., indoor environments) that are not accessible from a car.

In one embodiment, the portable device 103 executes or otherwise includes the location application 113 for extracting POI features 117 according to the various embodiments described herein. In addition or alternatively, the location platform 101 (e.g., cloud component) can perform one or more functions associated with extracting POI features 117 alone or in combination with the location application 113.

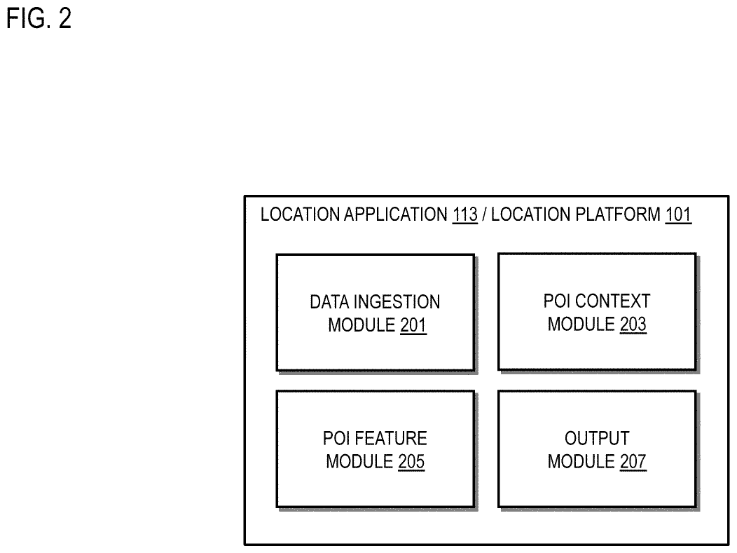

FIG. 2 is a diagram of the components of the location application 113 and/or location platform 101 capable of extracting and/or updating POI features 117, according to example embodiment(s). The location application 113 and/or location platform 101 include one or more components for extracting and/or updating POI features 117, according to the various embodiments described herein. It is contemplated that the functions of these components may be combined or performed by other components of equivalent functionality. As shown, in one embodiment, the location application 113 and/or location platform 101 includes a data ingestion module 201, a POI context module 203, a POI feature module 205, and an output module 207. The above presented modules and components of the location application 113 and/or location platform 101 can be implemented in hardware, firmware, software, or a combination thereof. Though depicted as separate entities in FIG. 1, it is contemplated that the location application 113 and/or location platform 101 may be implemented as a module of any of the components of the system 100 (e.g., a component of the services platform 123, services 125, content providers 127, and/or the like). In another embodiment, one or more of the modules 201-207 may be implemented as a cloud-based service, local service, native application, or combination thereof. The functions of the location application 113, location platform 101, and modules 201-207 are discussed with respect to the figures described below.

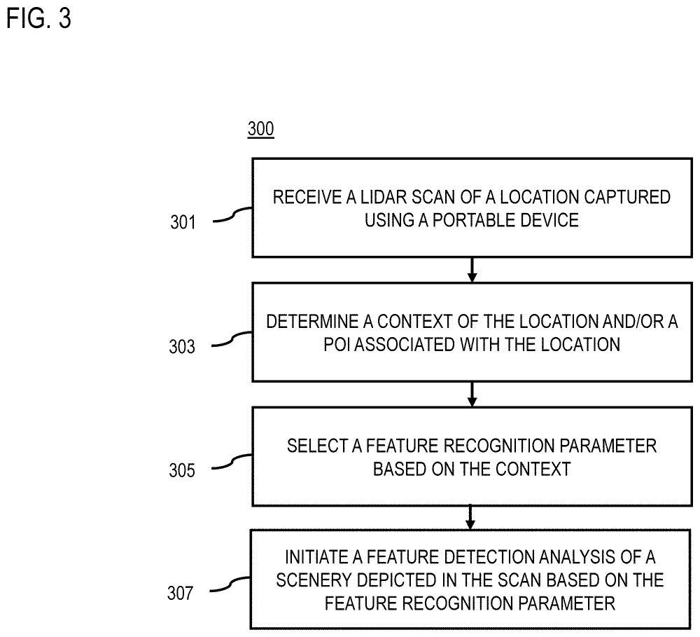

FIG. 3 is a flowchart of a process for extracting point-of-interest features based on depth sensor data captured by mobile devices, according to example embodiment(s). In various embodiments, the location application 113, location platform 101, and modules 201-207 may perform one or more portions of the process 300 and may be implemented in, for instance, a chip set including a processor and a memory as shown in FIG. 13. As such, the location application 113, location platform 101, and modules 201-207 can provide means for accomplishing various parts of the process 300, as well as means for accomplishing embodiments of other processes described herein in conjunction with other components of the system 100. Although the process 300 is illustrated and described as a sequence of steps, it is contemplated that various embodiments of the process 300 may be performed in any order or combination and need not include all of the illustrated steps.

In one embodiment, for example in step 301, the data ingestion module 201 can receive a Light Detection and Ranging (LiDAR) scan of a location (e.g., a living room of a private rental (e.g., Airbnb) property in FIG. 1B) captured using a LiDAR sensor (e.g., the LiDAR sensor 109) of a portable device (e.g., the portable device 103).

In one embodiment, in step 303, the POI context module 203 can determine a context of the location, a point of interest (POI) associated with the location, or a combination thereof. For instance, the context can include a location type, a POI type (e.g., restaurant, library, record store, supermarket in FIG. 1C), or a combination thereof queried from a geographic database (e.g., the geographic database 119). The location, for instance, can be any location that a user of the portable device 103 visits. When the user reaches the location, the user can activate the location application 113 of the portable device 103 to capture a LiDAR scan 107 using the LiDAR sensor 109. As noted above, although the embodiments described herein are discussed with respect to a LiDAR sensor 109, it is contemplated that any equivalent depth sensing sensor (e.g., any time-of-flight sensor including but not limited to a radar sensor) can be used. When used with other depth sensing sensors, the scan can be referred to herein as a depth sensing scan to extract POI features.

In another embodiment, the LiDAR scan 107 can be replaced with an image scan (e.g., captured by a camera of the portable device 103). For instance, the camera can create stereogram(s) with an illusion of depth therein by means of stereopsis for binocular vision, e.g., a pair of stereo images to be viewed using a stereoscope. The POI feature module 205 can combine stereogram techniques with machine learning (e.g., cellular neural network (CNN) analogic procedures) to extract stereo depth data, etc. for providing POI features as discussed with respect to the LiDAR scan 107. The image scans are useful when LiDAR sensors are unavailable or malfunctioning on some portable devices.

On the other hand, LiDAR resolution is generally much lower than traditional camera image resolution. Comparing with the image scan, the LiDAR scan 107 with lower resolution can better preserves privacy (e.g., by obscuring any personally identifiable features) while still preserving geometric features to uniquely represent a geographic environment. In one embodiment, the data ingestion module 201 can switch to a different scan technology based on availability, granularity requirement, etc.

In one embodiment, in step 305, the POI feature module 205 can select a feature recognition parameter based on the context. The feature recognition parameter can perform a feature detection analysis of a scenery depicted in the LiDAR scan. For instance, the feature recognition parameter can include a feature detector (e.g., applying a machine learning model tuned for the feature recognition parameter) to be used for the analysis. For example, when the POI context detection module 203 determines that the device location corresponds to a POI Restaurant Type, the POI feature module 205 can apply a machine learning model that has been trained to recognize features of a restaurant. If the application of the restaurant machine learning model is unsuccessful, the system 100 can use the unsuccessful result as a strong indication that the POI has changed its type from a restaurant.

In another embodiment, the feature recognition parameter can include one or more expected features (e.g., expected furniture, objects, decorations, etc. for the POI type), an expected number of the one or more expected features (e.g., expected numbers of the furniture, objects, decorations, etc. for the POI type), an expected arrangement of the one or more expected features (e.g., expected arrangement of the furniture, objects, decorations, etc. for the POI type), expected spatial dimensions of the one or more expected features (e.g., expected spatial dimensions of the furniture, objects, decorations, etc. for the POI type), or a combination thereof associated with the location, the POI, or a combination thereof.

In one embodiment, in step 307, the POI feature module 205 can initiate the feature detection analysis of the LiDAR scan (e.g., the LiDAR scan 107) based on the feature recognition parameter to identify a feature (e.g., tables in a restaurant), an attribute of the feature (e.g., dimensions, material, color, etc. of the table), or a combination thereof in the scenery. For instance, the feature can include furniture, objects, decorations, or a combination thereof associated with the location, the POI, or a combination thereof, and the attribute of the feature can include a number, a spatial arrangement (e.g., distances, orientations, etc.), a dimension, or a combination of the feature.

As other instances, the feature can include people at the location, the POI, or a combination thereof and the attribute of the feature can include an occupancy/people count. The POI feature module 205 can then determine an occupancy/crowdedness of the location, the POI, or a combination thereof based on the number of the people. For instance, in a restaurant, the POI feature module 205 can apply machine learning to know what to expect in term of image segmentation for the people.

In another embodiment, the data ingestion module 201 can retrieve one or more historical LiDAR scan results of the location. For instance, the one or more historical LiDAR scan results can indicate one or more historical features previously detected at the location or POI, an historical number of the one or more historical features, a historical arrangement of the one or more historical features, historical spatial dimensions of the one or more historical features, or a combination thereof. In this case, the feature recognition parameter can be further based on the one or more historical LiDAR scan results. In this case, the POI feature module 205 can detect a change at the location, the POI, or a combination thereof based on comparing the feature, the attribute of the feature, or a combination thereof identified in the LiDAR scan to the one or more historical LiDAR scan results. The output module 207 can then update a data record of a geographic database representing the location, the POI, or a combination thereof based on the identified feature, the identified attribute, the detected change, or a combination thereof.

The POI feature module 205 can determine one or more feature detection probabilities for a feature detector based one or more expected features, an expected number of the one or more expected features, an expected arrangement of the one or more expected features, expected spatial dimensions of the one or more expected features, or a combination thereof. As such, the feature, the attribute of the feature, or a combination thereof can be identified by the POI feature module 205 in the LiDAR scan based on the one or more feature detection probabilities.

In one embodiment, the output module 207 can store the feature, the attribute of the feature, or a combination thereof as metadata describing the location, the POI, or a combination thereof. The output module 207 can then provide a user interface for a location or POI search based on the metadata.

In one embodiment, e.g., to provide for a more consistent scanning experience, the output module 207 can generate a user interface that presents a scanning parameter for initiating the capturing of the LiDAR scan 107. By way of example, the scanning parameter includes, but is not limited to, a scanning duration, a scanning direction, a scanning orientation, or a combination thereof. The output module 207 then presents the user interface on the portable device 103 to direct a user of the portable device 103 on how to scan the environment. For example, the guidance could help improve the data collection experience, data quality, or outcome of using the POI feature(s) for a given use case etc. For instance, indoor LiDAR scans of hotels, private rental accommodations (e.g., Airbnb), restaurants, bars, etc. can capture relevant features which automatically enrich the descriptions without inputs from the POI owners/operators. Therefore, such descriptions can include a number of tables in a restaurant, a space between tables (for privacy and sanitary concerns), bed sizes in hotels, dimensions of a work desk, etc.

In one embodiment, the POI owners/operators can take advantage of the POI features of their competitors to improve the features of their own POI. For instance, a restaurant owner can model its floor space density against the one of the most/least popular restaurants. Any layout of the POI can be a characteristic/feature of the POI, such as materials, windows, natural/artificial lights, views, wall color, height of the ceiling (e.g., can be used for image projection, playing sports, e.g., basketball, flying drones, etc. of an exhibition halls). The enriched POI details can support advanced booking as discussed below.

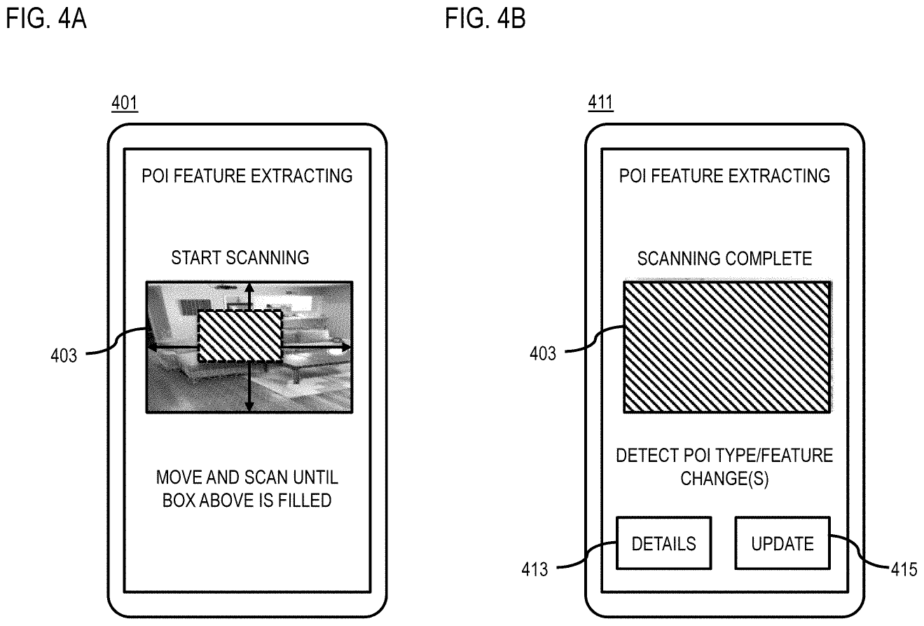

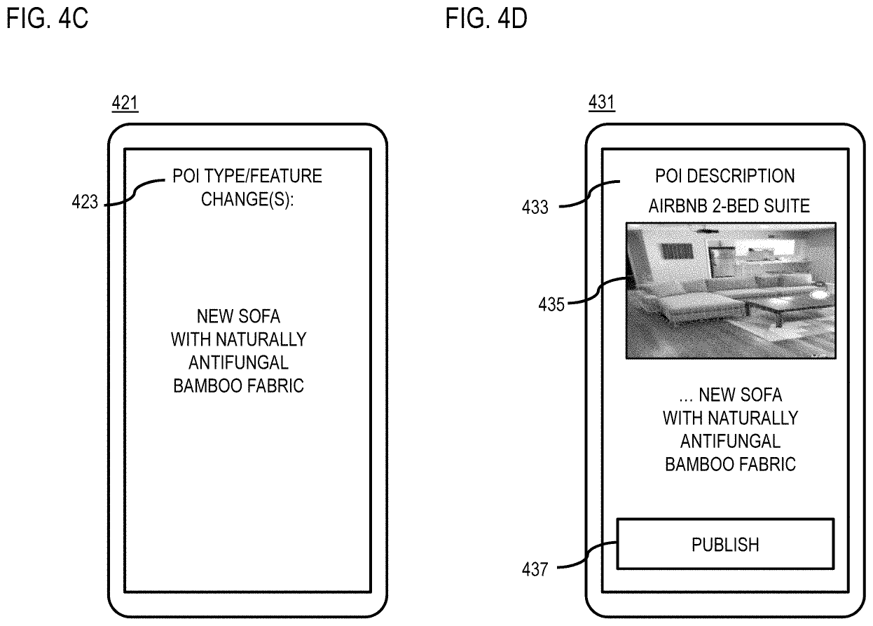

FIGS. 4A-4D are diagrams illustrating example user interfaces for capturing LiDAR scan(s) and extracting POI features, according to example embodiment(s). Example UI 401 of FIG. 4A presents a UI element 403 that indicates the orientation and directions to capture a LiDAR scan 107 for extracting POI features 117. In this example, the scanning directions to cover are represented by respective arrows in the UI element 403 and a shaded area in the UI element 403 indicating the area of the environment that has already been scanned. The UI 401 instructs the user to start scanning and moving the portable device 103 (e.g., the mobile phone 104a) while scanning to completely fill shade UI element 403. When the user has scanned the specified area corresponding to the UE element 403 (e.g., indicated by a completely shaded UI element 403 in UI 411 of FIG. 4B), a messaging indicating “scanning complete” can be displayed in the UI 411. Scanning, for instance, refers to moving the portable device 103 in different point directions and/or orientations so that the emitted laser pulses of LiDAR sensor 109 covers the area of interest to generate a LiDAR scan 107. Depending on the specification of the LiDAR sensor 109 and the distance to the surfaces being scanned, a typical LiDAR scan 109 can have varying resolutions (e.g., point spacing of less approximately 0.5 meters) and accuracy (e.g., 1-20 mm accuracy). As mentioned, LiDAR resolution is generally much lower than traditional camera image resolution. The benefit of this decreased resolution (relative to traditional camera images) is that this preserves privacy (e.g., by obscuring any personally identifiable features) while still preserving geometric features that can uniquely represent a geographic environment (e.g., relative positions of surfaces and/or objects in the environment).

The system 100 can process the LiDAR scan 107 to generate POI features 117 that is representative of the location of the portable device 103. The LiDAR scan 107, for instance, can be a point cloud of 3D coordinates representing the surfaces in the environment that has reflected the laser pulses of the LiDAR sensor. Accordingly, in one embodiment, the POI features 117 can simply include a point cloud representing all or at least a portion of the environment of the location included in the LiDAR scan 107. To save storage space and reduce computer resources for processing larger POI feature(s) and/or point cloud(s), the system 100 can crop the LiDAR scan 107 to depict a smaller area in the POI features 117. In addition or alternatively, the processing of the LiDAR scan 107 can comprise of extraction one or more features (e.g., walls, edges, corners, feature intersections, etc.) and including just the extracted features in the POI features 117.

After processing the LiDAR scan 107 based on the above-discussed embodiments, and the system 100 can display a messaging indicating “detect POI type/feature change(s)” in the UI 411, as well as two options of “Details” 413 and “Update” 415. Upon a user selection of “Details” 413, the system 100 can provide a UI 421 with a heading 423 of “POI type/feature change(s)” and a messaging indicating “new sofa with naturally antifungal bamboo fabric.” Upon a user selection of “Update” 415, the system 100 can provide a UI 431 with a heading 433 of “POI description 2-bed suite,” an image 435 of the suite, a POI description including “new sofa with naturally antifungal bamboo fabric”, and an option 437 of “Publish.” Upon a user selection of the option 437, the system 100 can publish the POI description, for example, on the POI website, the geographic database 119, etc.

In another embodiment, a head-mounted device, such as the augmented-reality device 104b is used to replace the mobile phone 104a. In this case, the system 100 can prompt the user to move the head to perform the scan, which is more intuitive and naturally align with the user's gaze.

The POI features 117 and corresponding locations can be created and/or stored locally at the portable devices 103, devices 105, or any other edge device. In addition or alternately, the reference LiDAR point clouds can be created and/or stored by cloud components such as, but not limited to, the location platform 101, services platform 123, services 125, and/or content providers 127.

In one embodiment, the reference LiDAR point clouds can be generated procedurally from digital map data (e.g., map data of the geographic database 119). For example, if the map includes, 3D modeling data of buildings or other features at a given location. The 3D modeling data can be converted to a 3D point cloud representation from which the corresponding POI feature(s) can be created without having to actually scan the location using a LiDAR sensor or equivalent depth sensing sensor.

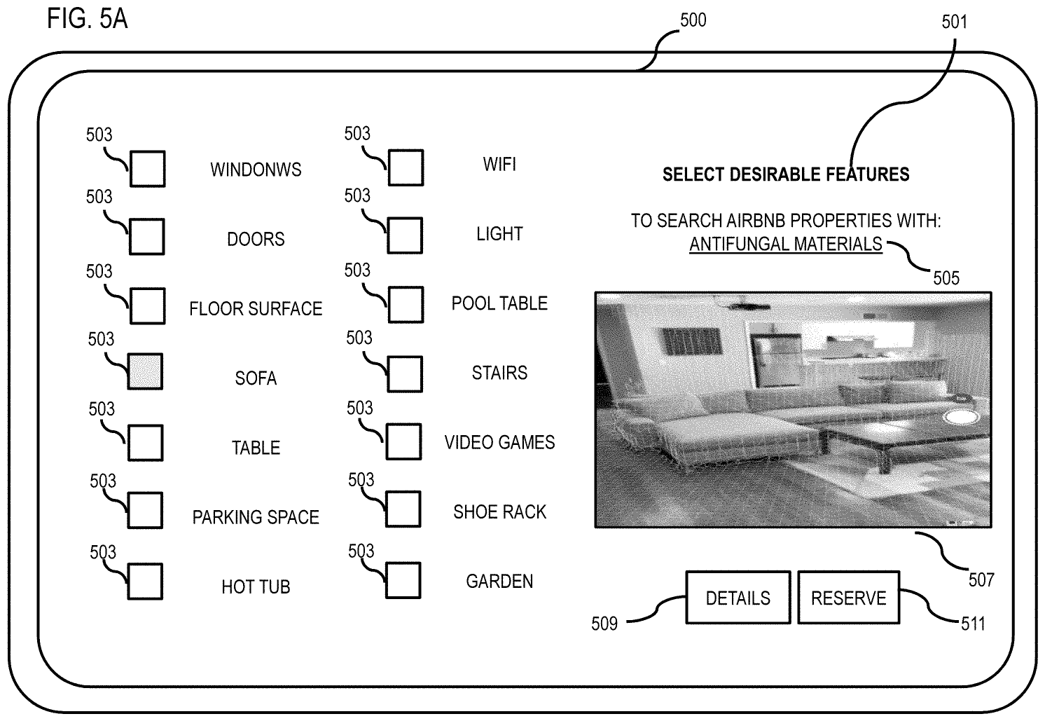

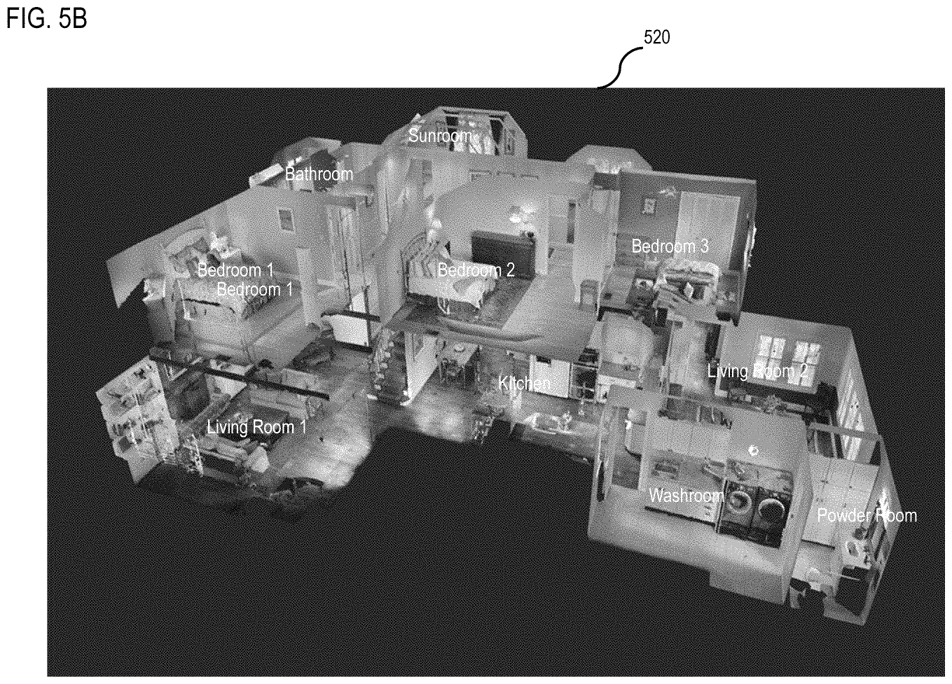

FIGS. 5A-5B are diagrams illustrating example user interfaces for using extracted POI features, according to example embodiment(s). For example, FIG. 5A illustrates an example UI 500 for applying POI features in a reservation context. In this context, the UI 500 shows a message 501 of “Select desirable features”, lists POI features 503 for user selections in order to search for desirable rental properties, and a prompt 505 to invite a user to enter criteria “to search private rental properties with.” For instance, the user is allergic to fungi, and entered “antifungal materials” in a field to be applied to at least “sofa.” In addition, the system 100 can prompt the user to prioritize the criteria. The system 100 can search based on the prioritized criteria, and find one or more properties with a sofa of antifungal fabric as shown in an image 507. The user can enter more criteria to narrow down the search. The system 100 can search and/or rank POIs to visit, for hire, etc. for a user.

The UI 500 also shows two options of “Details” 509 and “Reserve” 511. Upon a user selection of “Details” 509, the system 100 can provide a UI 520 in FIG. 5B with a 3D image built form LiDAR scans and showing objects and features of each room of a property meeting all user criteria. Upon a user selection of “Reserve” 511, the system 100 can make a reservation of the property for the user.

In one embodiment, it is contemplated that the system 100 can support cloud and/or edge-based features. Examples of cloud-based features include but are not limited to:
Scanning data (e.g., LiDAR scans 107, POI features 117, and/or 3D POI models) stored on the cloud (e.g., location platform 101, services platform 123, services 125, content providers 127, geographic database 119, etc.), including crowdsourced data; and
Leveraging 5G or better capabilities of the communication network 121 to connect with edge devices for faster transmission of the venue scan data, image segmentation and object classification results, etc.

Examples of edge-based image segmentation and/or object classification features include but are not limited to:
For live matching of POI features 117 and/or 3D POI models with reference POI features and point clouds; and
Extracting the relevant features from the LiDAR scans 107 to transmit to the cloud for efficiency.

Returning to FIG. 1, as shown, the system 100 includes a location application 113 and/or location platform 101 for creating POI features 117 and/or 3D POI models. In one embodiment, the location application 113 and/or location platform 101 have connectivity over the communication network 121 to each other, the services platform 123 that provides one or more services 125 that can use the POI features 117 and/or 3D POI models to perform one or more functions, or to provide data for extracting the POI features. By way of example, the services 125 may be third party services and include but is not limited to mapping services, navigation services, travel planning services, notification services, social networking services, content (e.g., audio, video, images, etc.) provisioning services, application services, storage services, contextual information determination services, location-based services, information-based services (e.g., weather, news, etc.), etc. In one embodiment, the services 125 uses the output of the location application 113 and/or location platform 101 (e.g., POI features 117 and/or 3D POI models) to provide functions such as navigation, mapping, other location-based services, etc. to the portable device 103, devices 105, and/or other components of the system 100.

In one embodiment, the location application 113 and/or location platform 101 may be a platform with multiple interconnected components. The location application 113 and/or location platform 101 may have access to or otherwise include multiple servers, intelligent networking devices, computing devices, components, and corresponding software for combining location data sources according to the various embodiments described herein. In addition, it is noted that the location application 113 and/or location platform 101 may be a separate entity of the system 100; a part of one or more services 125, a part of the services platform 123; or included within components of the portable device 103 and/or device 105.

In one embodiment, content providers 127 may provide content or data (e.g., including network feature data, graph data, geographic data, etc.) to the geographic database 119, the location application 113, the location platform 101, the services platform 123, the services 125, and/or the portable device 103. The content provided may be any type of content, such as reference POI features and/or point clouds, map content, textual content, audio content, video content, image content, etc. In one embodiment, the content providers 127 may also store content associated with the geographic database 119, location application 113 and/or location platform 101, services platform 123, services 125, and/or any other component of the system 100. In another embodiment, the content providers 127 may manage access to a central repository of data, and offer a consistent, standard interface to data, such as a repository of the geographic database 119.

In one embodiment, the portable device 103 may execute location applications 113 to use or extract point-of-interest features based on depth sensor data captured by mobile devices according to the embodiments described herein. By way of example, the location applications 113 may also be any type of application that is executable on the portable device 103 and/or device 105, such as, but not limited to, routing applications, mapping applications, location-based service applications, navigation applications, device control applications, content provisioning services, camera/imaging application, media player applications, social networking applications, calendar applications, and the like. In one embodiment, the location applications 113 may act as a client for the location platform 101 and perform one or more functions associated with generating or using POI features 117 and/or 3D POI models alone or in combination with the location platform 101.

By way of example, the portable device 103 and/or device 105 is or can include any type of embedded system, mobile terminal, fixed terminal, or portable terminal including a mobile device, augmented reality device, a personal navigation device, mobile handset, station, unit, device, multimedia computer, multimedia tablet, Internet node, communicator, desktop computer, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, or any combination thereof, including the accessories and peripherals of these devices, or any combination thereof. It is also contemplated that the portable device 103 and/or device 105 can support any type of interface to the user (such as “wearable” circuitry, etc.). In one embodiment, the portable device 103 and/or device 105 may be associated with or be a component of any other device.

In one embodiment, the portable device 103 and/or device 105 are configured with various sensors for generating or collecting depth sensing data (e.g., LiDAR scans 107) and related geographic data. By way of example, the sensors may include a LiDAR sensor 109, any other depth sensing sensor, Global Satellite Positioning System (GNSS) sensor for gathering location data (e.g., GPS), IMUs, a network detection sensor for detecting wireless signals or receivers for different short-range communications (e.g., Bluetooth, Wi-Fi, Li-Fi, near field communication (NFC) etc.), temporal information sensors, a camera/imaging sensor for gathering image data (e.g., the camera sensors may automatically capture road sign information, images of road obstructions, etc. for analysis), an audio recorder for gathering audio data, and the like.

Other examples of sensors of the portable device 103 and/or device 105 may include light sensors, orientation sensors augmented with height sensors and acceleration sensor, tilt sensors to detect the degree of incline or decline (e.g., slope) along a path of travel, moisture sensors, pressure sensors, etc. In a further example embodiment, sensors about the perimeter of the portable device 103 and/or device 105 may detect the relative distance of the device other features in the environment including but not limited to buildings, objects, terrain, etc. In one scenario, the sensors may detect weather data, traffic information, or a combination thereof. In one embodiment, the portable device 103 and/or device 105 may include GPS or other satellite-based receivers to obtain geographic coordinates from positioning satellites for determining current location and time. Further, the location can be determined by visual odometry, triangulation systems such as A-GPS, Cell of Origin, or other location extrapolation technologies.

In one embodiment, the communication network 121 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UNITS), etc., as well as any other suitable wireless medium, e.g., worldwide interoperability for microwave access (WiMAX), Long Term Evolution (LTE) networks, 5G New Radio networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

By way of example, the location application 113, location platform 101, services platform 123, services 125, portable device 103, device 105, and/or content providers 127 communicate with each other and other components of the system 100 using well known, new or still developing protocols. In this context, a protocol includes a set of rules defining how the network nodes within the communication network 121 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

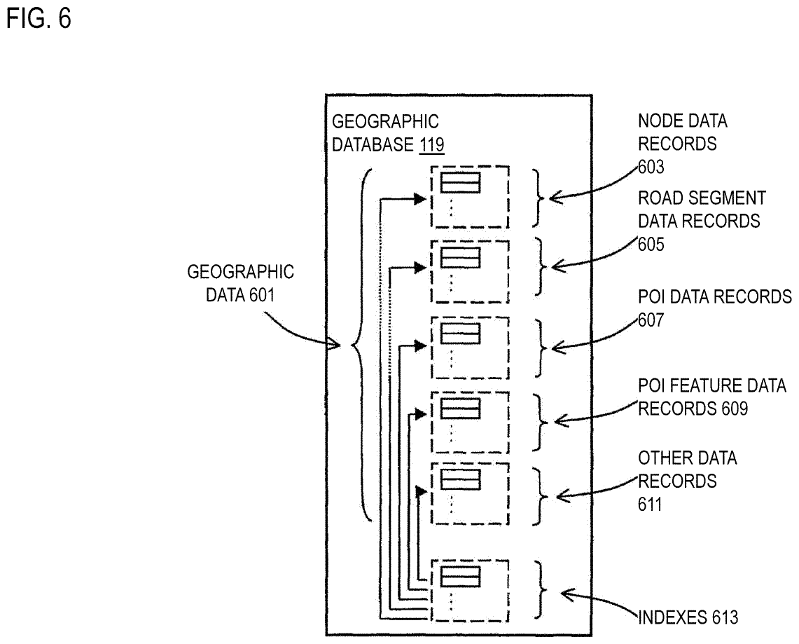

FIG. 6 is a diagram of a geographic database (such as the database 119), according to one embodiment. In one embodiment, the geographic database 119 includes geographic data 601 used for (or configured to be compiled to be used for) mapping and/or navigation-related services, such as for video odometry based on the parametric representation of lanes include, e.g., encoding and/or decoding parametric representations into lane lines. In one embodiment, the geographic database 119 include high resolution or high definition (HD) mapping data that provide centimeter-level or better accuracy of map features. For example, the geographic database 119 can be based on Light Detection and Ranging (LiDAR) or equivalent technology to collect very large numbers of 3D points depending on the context (e.g., a single street/scene, a country, etc.) and model road surfaces and other map features down to the number lanes and their widths. In one embodiment, the mapping data (e.g., mapping data records 611) capture and store details such as the slope and curvature of the road, lane markings, roadside objects such as signposts, including what the signage denotes. By way of example, the mapping data enable highly automated vehicles to precisely localize themselves on the road.

In one embodiment, geographic features (e.g., two-dimensional or three-dimensional features) are represented using polygons (e.g., two-dimensional features) or polygon extrusions (e.g., three-dimensional features). For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions. Accordingly, the terms polygons and polygon extrusions as used herein can be used interchangeably.

In one embodiment, the following terminology applies to the representation of geographic features in the geographic database 119.

“Node”—A point that terminates a link.

“Line segment”—A straight line connecting two points.

“Link” (or “edge”)—A contiguous, non-branching string of one or more line segments terminating in a node at each end.

“Shape point”—A point along a link between two nodes (e.g., used to alter a shape of the link without defining new nodes).

“Oriented link”—A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 119 follows certain conventions. For example, links do not cross themselves and do not cross each other except at a node. Also, there are no duplicated shape points, nodes, or links. Two links that connect each other have a common node. In the geographic database 119, overlapping geographic features are represented by overlapping polygons. When polygons overlap, the boundary of one polygon crosses the boundary of the other polygon. In the geographic database 119, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic database 119 includes node data records 603, road segment or link data records 605, POI data records 607, POI feature data records 609, mapping data records 611, and indexes 613, for example. More, fewer or different data records can be provided. For instance, the POI feature data records 609 and the POI data records 607 can share data such as LiDAR scans, POI feature data (including POI time-dependent features), POI classification results, etc. As another instance, the POI feature data records 609 are totally or partially merged into the POI data records 607. In one embodiment, additional data records (not shown) can include cartographic (“carto”) data records, routing data, and maneuver data. In one embodiment, the indexes 613 may improve the speed of data retrieval operations in the geographic database 119. In one embodiment, the indexes 613 may be used to quickly locate data without having to search every row in the geographic database 119 every time it is accessed. For example, in one embodiment, the indexes 613 can be a spatial index of the polygon points associated with stored feature polygons.

In exemplary embodiments, the road segment data records 605 are links or segments representing roads, streets, or paths, as can be used in the calculated route or recorded route information for determination of one or more personalized routes. The node data records 603 are end points (such as intersections) corresponding to the respective links or segments of the road segment data records 605. The road link data records 605 and the node data records 603 represent a road network, such as used by vehicles, cars, and/or other entities. Alternatively, the geographic database 119 can contain path segment and node data records or other data that represent pedestrian paths or areas in addition to or instead of the vehicle road record data, for example.

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 119 can include data about the POIs and their respective locations in the POI data records 607. The geographic database 119 can also include data about places, such as cities, towns, or other communities, and other geographic features, such as bodies of water, mountain ranges, etc. Such place or feature data can be part of the POI data records 607 or can be associated with POIs or POI data records 607 (such as a data point used for displaying or representing a position of a city). In one embodiment, certain attributes, such as lane marking data records, mapping data records and/or other attributes can be features or layers associated with the link-node structure of the database.

In one embodiment, the geographic database 119 can also include POI feature data records 609 for storing LiDAR scans, POI feature data (including POI time-dependent features), POI classification results, object counts in POIs, POI occupancy data, POI 3D models, references to machine learning models for POI/feature detections, training data, prediction models, annotated observations, computed featured distributions, sampling probabilities, and/or any other data generated or used by the system 100 according to the various embodiments described herein. By way of example, the POI feature data records 609 can be associated with one or more of the node records 603, road segment records 605, and/or POI data records 607 to support localization or visual odometry based on the features stored therein and the corresponding estimated quality of the features. In this way, the records 609 can also be associated with or used to classify the characteristics or metadata of the corresponding records 603, 605, and/or 607.

In one embodiment, as discussed above, the mapping data records 611 model road surfaces and other map features to centimeter-level or better accuracy. The mapping data records 611 also include lane models that provide the precise lane geometry with lane boundaries, as well as rich attributes of the lane models. These rich attributes include, but are not limited to, lane traversal information, lane types, lane marking types, lane level speed limit information, and/or the like. In one embodiment, the mapping data records 611 are divided into spatial partitions of varying sizes to provide mapping data to vehicles and other end user devices with near real-time speed without overloading the available resources of the vehicles and/or devices (e.g., computational, memory, bandwidth, etc. resources).

In one embodiment, the mapping data records 611 are created from high-resolution 3D mesh or point-cloud data generated, for instance, from LiDAR-equipped vehicles. The 3D mesh or point-cloud data are processed to create 3D representations of a street or geographic environment at centimeter-level accuracy for storage in the mapping data records 611.

In one embodiment, the mapping data records 611 also include real-time sensor data collected from probe vehicles in the field. The real-time sensor data, for instance, integrates real-time traffic information, weather, and road conditions (e.g., potholes, road friction, road wear, etc.) with highly detailed 3D representations of street and geographic features to provide precise real-time also at centimeter-level accuracy. Other sensor data can include vehicle telemetry or operational data such as windshield wiper activation state, braking state, steering angle, accelerator position, and/or the like.

In one embodiment, the geographic database 119 can be maintained by the content provider 121 in association with the services platform 123 (e.g., a map developer). The map developer can collect geographic data to generate and enhance the geographic database 119. There can be different ways used by the map developer to collect data. These ways can include obtaining data from other sources, such as municipalities or respective geographic authorities. In addition, the map developer can employ field personnel to travel by vehicle (e.g., vehicles and/or user devices) along roads throughout the geographic region to observe features and/or record information about them, for example. Also, remote sensing, such as aerial or satellite photography, can be used.

The geographic database 119 can be a master geographic database stored in a format that facilitates updating, maintenance, and development. For example, the master geographic database or data in the master geographic database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a vehicle or a user device, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for extracting point-of-interest features based on depth sensor data captured by mobile devices may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

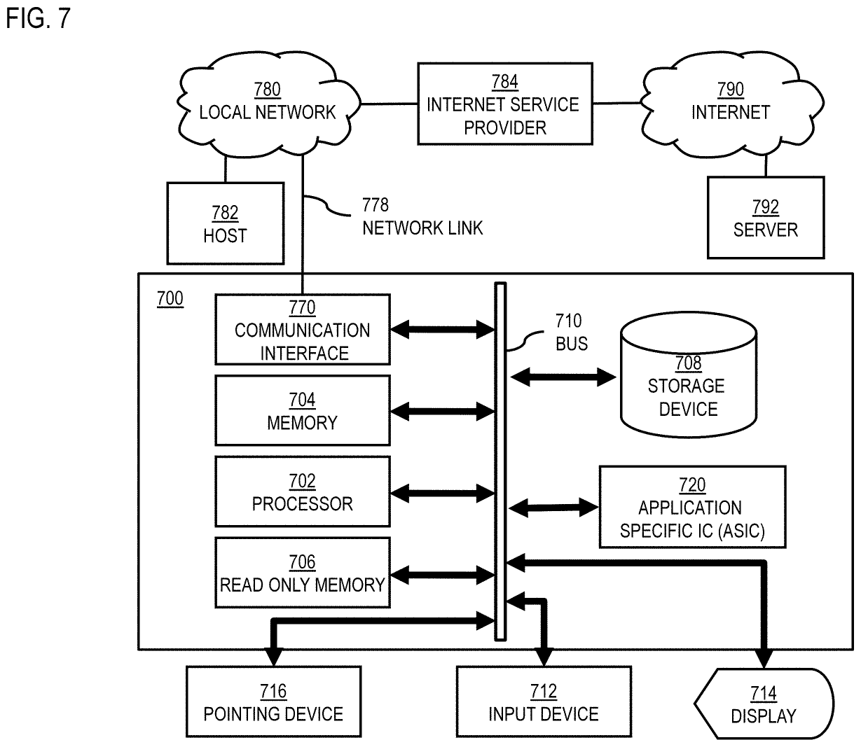

FIG. 7 illustrates a computer system 700 upon which an embodiment of the invention may be implemented. Computer system 700 is programmed (e.g., via computer program code or instructions) to extract point-of-interest features based on depth sensor data captured by mobile devices as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 710 includes one or more parallel conductors of information so that information is transferred quickly among devices coupled to the bus 710. One or more processors 702 for processing information are coupled with the bus 710.

A processor 702 performs a set of operations on information as specified by computer program code related to extracting point-of-interest features based on depth sensor data captured by mobile devices. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RANI) or other dynamic storage device, stores information including processor instructions for extracting point-of-interest features based on depth sensor data captured by mobile devices. Dynamic memory allows information stored therein to be changed by the computer system 700. RANI allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or other static storage device coupled to the bus 710 for storing static information, including instructions, which is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, which persists even when the computer system 700 is turned off or otherwise loses power.

Information, including instructions for extracting point-of-interest features based on depth sensor data captured by mobile devices, is provided to the bus 710 for use by the processor from an external input device 712, such as a keyboard containing alphanumeric keys operated by a human user, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT) or a liquid crystal display (LCD), or plasma screen or printer for presenting text or images, and a pointing device 716, such as a mouse or a trackball or cursor direction keys, or motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of application specific ICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, which carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 121 for extracting point-of-interest features based on depth sensor data captured by mobile devices to the location platform 101.

The term computer-readable medium is used herein to refer to any medium that participates in providing information to processor 702, including instructions for execution. Such a medium may take many forms, including, but not limited to, non-volatile media, volatile media and transmission media. Non-volatile media include, for example, optical or magnetic disks, such as storage device 708. Volatile media include, for example, dynamic memory 704. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790.

A computer called a server host 792 connected to the Internet hosts a process that provides a service in response to information received over the Internet. For example, server host 792 hosts a process that provides information representing video data for presentation at display 714. It is contemplated that the components of system can be deployed in various configurations within other computer systems, e.g., host 782 and server 792.

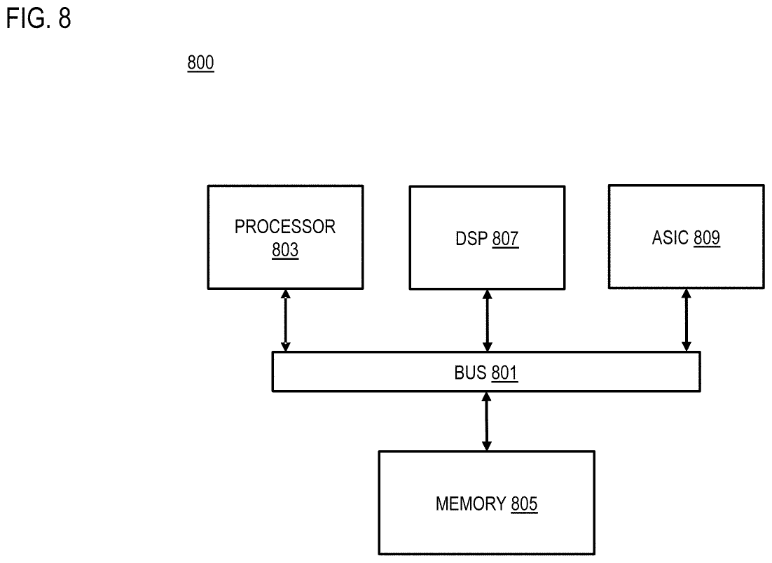

FIG. 8 illustrates a chip set 800 upon which an embodiment of the invention may be implemented. Chip set 800 is programmed to extract point-of-interest features based on depth sensor data captured by mobile devices as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to extract point-of-interest features based on depth sensor data captured by mobile devices. The memory 805 also stores the data associated with or generated by the execution of the inventive steps.

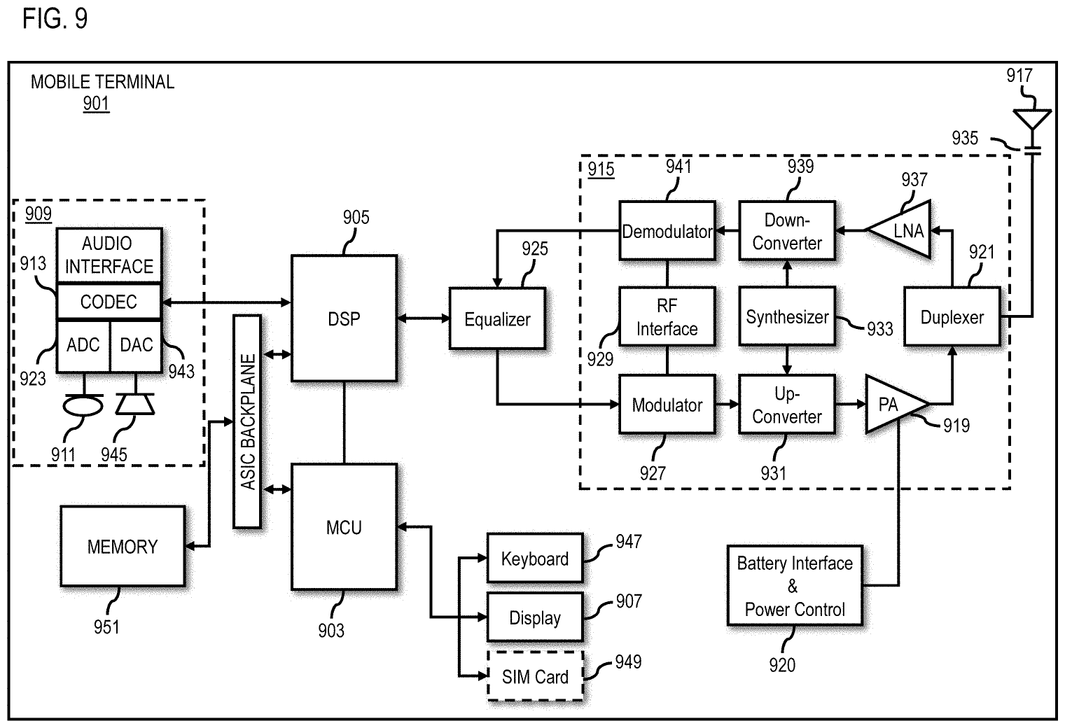

FIG. 9 is a diagram of exemplary components of a mobile terminal 901 (e.g., handset or vehicle or part thereof) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile station functions that offer automatic contact matching. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile station 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UNITS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903—which can be implemented as a Central Processing Unit (CPU) (not shown).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile station 901 to extract point-of-interest features based on depth sensor data captured by mobile devices. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the station. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile station 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 951 may be, but not limited to, a single memory, CD, DVD, ROM, RAM, EEPROM, optical storage, or any other non-volatile or non-transitory storage medium capable of storing digital data.

An optionally incorporated SIM card 949 carries, for instance, important information, such as the cellular phone number, the carrier supplying service, subscription details, and security information. The SIM card 949 serves primarily to identify the mobile station 901 on a radio network. The card 949 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
receiving a Light Detection and Ranging (LiDAR) scan of a location captured using a LiDAR sensor of a portable device;
determining a context of the location, a point of interest (POI) associated with the location, or a combination thereof;
selecting a feature recognition parameter based on the context, wherein the feature recognition parameter performs a feature detection analysis of a scenery depicted in the LiDAR scan; and
initiating the feature detection analysis of the LiDAR scan based on the feature recognition parameter to identify a feature, an attribute of the feature, or a combination thereof in the scenery.

2. The method of claim 1, wherein the context includes a location type, a POI type, or a combination thereof queried from a geographic database.

3. The method of claim 1, further comprising:
retrieving one or more historical LiDAR scan results of the location,
wherein the one or more historical LiDAR scan results indicate one or more historical features previously detected at the location or POI, an historical number of the one or more historical features, a historical arrangement of the one or more historical features, historical spatial dimensions of the one or more historical features, or a combination thereof, and
wherein the feature recognition parameter is further based on the one or more historical LiDAR scan results.

4. The method of claim 3, further comprising:
detecting a change at the location, the POI, or a combination thereof based on comparing the feature, the attribute of the feature, or a combination thereof identified in the LiDAR scan to the one or more historical LiDAR scan results.

5. The method of claim 4, further comprising:
updating a data record of a geographic database representing the location, the POI, or a combination thereof based on the identified feature, the identified attribute, the detected change, or a combination thereof.

6. The method of claim 1, wherein the feature recognition parameter includes a feature detector to be used for the analysis.

7. The method of claim 1, wherein the feature recognition parameter includes one or more expected features, an expected number of the one or more expected features, an expected arrangement of the one or more expected features, expected spatial dimensions of the one or more expected features, or a combination thereof associated with the location, the POI, or a combination thereof.

8. The method of claim 7, further comprising:
determining one or more feature detection probabilities for a feature detector based one or more expected features, an expected number of the one or more expected features, an expected arrangement of the one or more expected features, expected spatial dimensions of the one or more expected features, or a combination thereof,
wherein the feature, the attribute of the feature, or a combination thereof is identified in the LiDAR scan based on the one or more feature detection probabilities.

9. The method of claim 1, further comprising:
storing the feature, the attribute of the feature, or a combination thereof as metadata describing the location, the POI, or a combination thereof.

10. The method of claim 9, further comprising:
providing a user interface for a location or POI search based on the metadata.

11. The method of claim 1, wherein the feature includes furniture, objects, decorations, or a combination thereof associated with the location, the POI, or a combination thereof, and wherein the attribute of the feature includes a number, a spatial arrangement, a dimension, or a combination of the feature.

12. The method of claim 1, wherein the feature includes people at the location, the POI, or a combination thereof, and wherein the attribute of the feature includes a number of the people.

13. The method of claim 12, further comprising:
determining an occupancy of the location, the POI, or a combination thereof based on the number of the people.

14. An apparatus comprising:
at least one processor; and
at least one memory including computer program code for one or more programs,
the at least one memory and the computer program code configured to, within the at least one processor, cause the apparatus to perform at least the following,
receive a scan of a location captured using a sensor of a portable device;
determine a context of the location, a point of interest (POI) associated with the location, or a combination thereof;
select a feature recognition parameter based on the context, wherein the feature recognition parameter performs a feature detection analysis of a scenery depicted in the scan; and
initiate the feature detection analysis of the scan based on the feature recognition parameter to identify a feature, an attribute of the feature, or a combination thereof in the scenery.

15. The apparatus of claim 14, wherein the scan is a LiDAR scan, an image scan, or a combination thereof.

16. The apparatus of claim 14, wherein the context includes a location type, a POI type, or a combination thereof queried from a geographic database

17. The apparatus of claim 14, wherein the apparatus is further caused to:
retrieve one or more historical scan results of the location,
wherein the one or more historical scan results indicate one or more historical features previously detected at the location or POI, an historical number of the one or more historical features, a historical arrangement of the one or more historical features, historical spatial dimensions of the one or more historical features, or a combination thereof, and
wherein the feature recognition parameter is further based on the one or more historical scan results.

18. A non-transitory computer-readable storage medium carrying one or more sequences of one or more instructions which, when executed by one or more processors, cause an apparatus to perform:
receiving a Light Detection and Ranging (LiDAR) scan of a location captured using a LiDAR sensor of a portable device;
determining a context of the location, a point of interest (POI) associated with the location, or a combination thereof;
selecting a feature recognition parameter based on the context, wherein the feature recognition parameter performs a feature detection analysis of a scenery depicted in the LiDAR scan; and
initiating the feature detection analysis of the LiDAR scan based on the feature recognition parameter to identify a feature, an attribute of the feature, or a combination thereof in the scenery.

19. The non-transitory computer-readable storage medium of claim 18, wherein the context includes a location type, a POI type, or a combination thereof queried from a geographic database.

20. The non-transitory computer-readable storage medium of claim 18, wherein the apparatus is caused to further perform:
retrieving one or more historical LiDAR scan results of the location,
wherein the one or more historical LiDAR scan results indicate one or more historical features previously detected at the location or POI, an historical number of the one or more historical features, a historical arrangement of the one or more historical features, historical spatial dimensions of the one or more historical features, or a combination thereof, and
wherein the feature recognition parameter is further based on the one or more historical LiDAR scan results.
